(19) United States
(12) Patent Application Publication
(10) Pub. No.: US 2026/0357650 A1
(43) Pub. Date: Nov. 12, 2026

(54) ROLLING STRUCTURE

(71) Applicant: FRESH SPRING INTERNATIONAL, INC., New Taipei City (TW)

(72) Inventor: Chih-Ming HSIEH, New Taipei City (TW)

(21) Appl. No.: 19/229,766

(22) Filed: Jun. 5, 2025

(30) Foreign Application Priority Data
May 7, 2025 (TW) 114117168

(51) Int. Cl. E06B 9/44

(52) U.S. Cl. CPC E06B 9/44

(57) ABSTRACT

A rolling structure configured to be fixed to a supporting surface and including a fixing bracket, a fixed rod, at least one holding device and a rollable piece. The fixing bracket is configured to be fixed to the supporting surface. The fixed rod is fixed to the fixing bracket. The at least one holding device includes an inner barrel, an outer barrel and an elastic plate. The inner barrel is sleeved on and fixed to the fixed rod. The outer barrel is rotatably sleeved on the inner barrel. The outer barrel and the inner barrel are coaxial. The elastic plate is wound into loops. Two opposite ends of the elastic plate are fixed to the outer barrel and the inner barrel, respectively. A side of the rollable piece is fixed to the outer barrel.

### CROSS-REFERENCE TO RELATED APPLICATIONS

This non-provisional application claims priority under 35 U.S.C. § 119(a) of Patent Application No(s). 114117168 filed in Taiwan, R.O.C. on May 7th, 2025, the entire contents of which are hereby incorporated by reference in their entirety for any purpose.

### Technical Field

The disclosure relates to a rolling structure, more particularly to a rolling structure including a rollable piece.

### Background

In general, to control the amount of the light passing through the window, the curtain or slats of a roller blind are lowered/raised by a raising mechanism. In addition, a pull cord is included in the roller blind to facilitate the raising mechanism to lower/raise the curtain or slats.

However, the pull cord hang on a side of the window does not meet the safety standard in most of countries. That is, conventional roller blind is unable to facilitate the curtain or slats to be lowered/raised while meeting the safety standard.

### SUMMARY

The disclosure provides a rolling structure which facilitates the rollable piece to be lowered/raised while meeting the safety standard by cooperating the elastic plate with the outer barrel and the inner barrel that are coaxial.

One embodiment of this disclosure provides a rolling structure configured to be fixed to a supporting surface and including a fixing bracket, a fixed rod, at least one holding device and a rollable piece. The fixing bracket is configured to be fixed to the supporting surface. The fixed rod is fixed to the fixing bracket. The at least one holding device includes an inner barrel, an outer barrel and an elastic plate. The inner barrel is sleeved on and fixed to the fixed rod. The outer barrel is rotatably sleeved on the inner barrel. The outer barrel and the inner barrel are coaxial. The elastic plate is wound into loops. Two opposite ends of the elastic plate are fixed to the outer barrel and the inner barrel, respectively. A side of the rollable piece is fixed to the outer barrel.

According to the rolling structure disclosed by above embodiments, the outer barrel and the inner barrel are coaxial, and two opposite ends of the elastic plate wound into loops are fixed to the outer barrel and the inner barrel, respectively. Thus, the elastic force generated by the elastic plate holds the rollable piece in the desired height after the rollable piece is released. In this way, the rollable piece is facilitated to be lowered/raised while allowing the rolling structure to meet the safety standard.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a rolling structure of one embodiment of the disclosure;

FIGS. 2 and 3 are perspective exploded views of the rolling structure in FIG. 1;

FIG. 4 is a perspective cross-sectional view of the rolling structure taken along line 4-4 in FIG. 1;

FIG. 5 is a cross-sectional view of the rolling structure taken along line 5-5 in FIG. 1; and

FIGS. 6-8 show the operation of the rolling structure in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

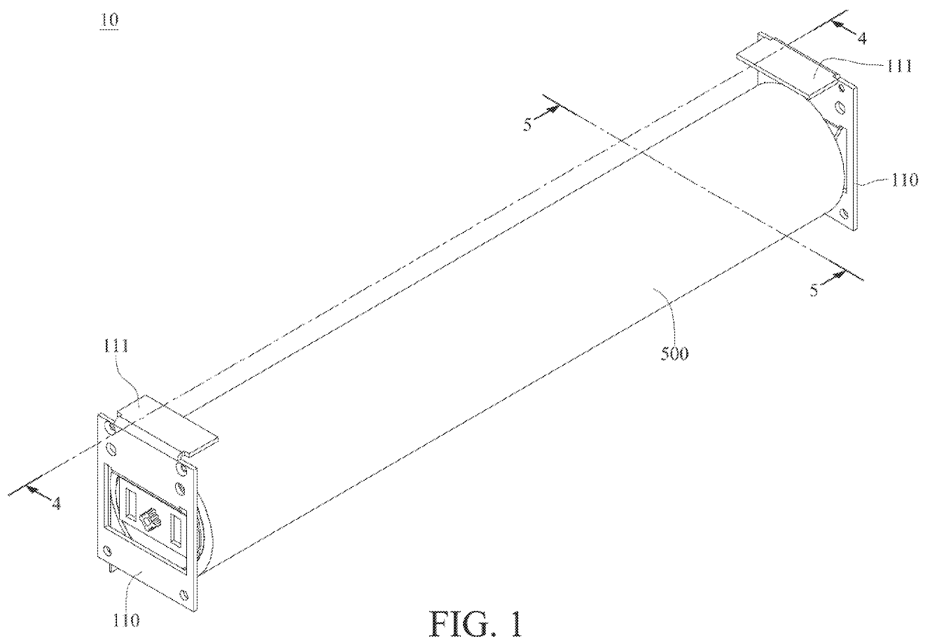

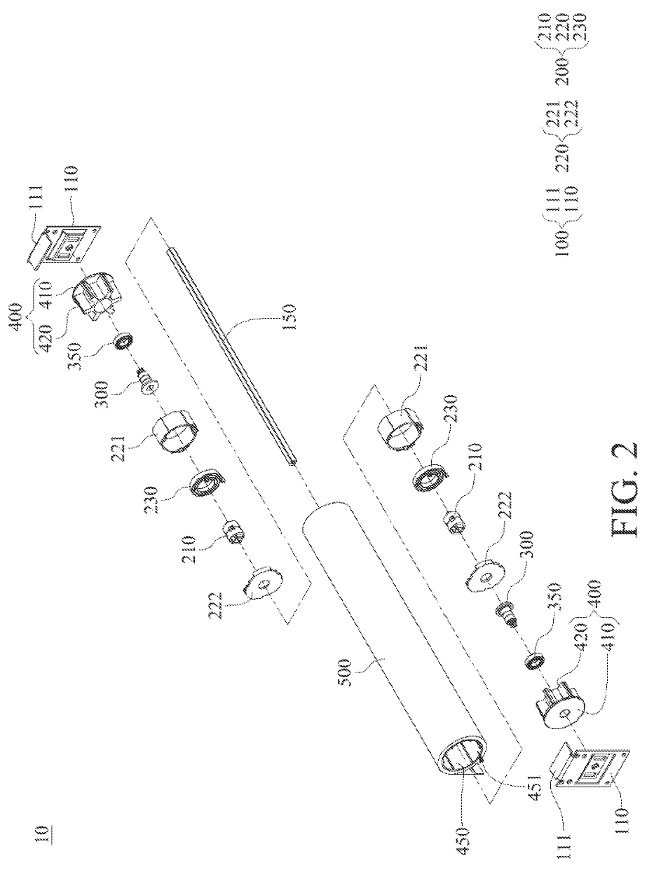

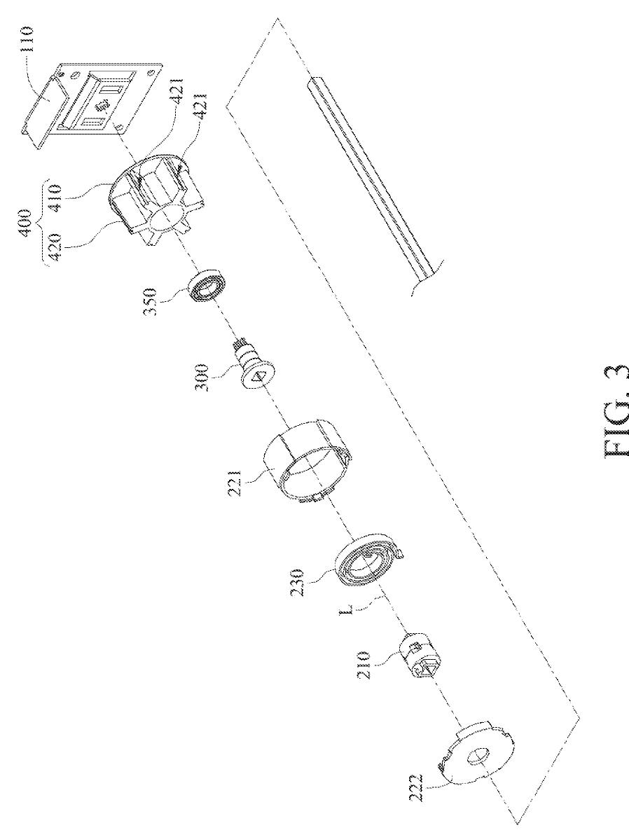

Please refer to FIGS. 1-3. FIG. 1 is a perspective view of a rolling structure 10 of one embodiment of the disclosure. FIGS. 2 and 3 are perspective exploded views of the rolling structure 10 in FIG. 1.

In this embodiment, the rolling structure 10 is, for example, a roller blind. The rolling structure 10 is configured to be fixed on a supporting surface (not shown), and includes, for example, a fixing bracket 100, a fixed rod 150, a plurality of holding devices 200, two fasteners 300, two bearings 350, two supporting cover plates 400, a roller 450 and a rollable piece 500. The supporting surface is, for example, a wall surface.

The fixing bracket 100 is configured to be fixed to the supporting surface. In this embodiment, the fixing bracket 100 includes, for example, two fixing plates 110. The two fixing plates 110 each have a protruding plate 111 configured to be fixed to the supporting surface. The fixed rod 150 is fixed to the fixing bracket 100. Specifically, two opposite ends of the fixed rod 150 are fixed to the two fixing plates 110, respectively.

In this embodiment, the holding devices 200 are spaced apart from each other axially. In addition, each holding device 200 includes an inner barrel 210, an outer barrel 220 and an elastic plate 230. The inner barrel 210 is sleeved on and fixed to the fixed rod 150. The outer barrel 220 is rotatably sleeved on the inner barrel 210. The outer barrel 220 and the inner barrel 210 are coaxial (e.g., both of the outer barrel 220 and the inner barrel 210 are disposed along a central line L). In this embodiment, the outer barrel 220 includes, for example, a base 221 and a side cover 222. The side cover 222 is disposed on a side of the base 221. The elastic plate 230 is located in the base 221, and is covered by the side cover 222. For example, the elastic plate 230 is wound into loops about the central line L. Further, two opposite ends of the elastic plate 230 are fixed to the base 221 of the outer barrel 220 and the inner barrel 210, respectively.

In this embodiment, the elastic plate 230 includes, for example, a first loading state and a second loading state. An elastic force generated by the elastic plate 230 in the first loading state is greater than an elastic force generated by the elastic plate 230 in the second loading state. When the elastic plate 230 that is totally wound is unwound, it changes from the second loading state to the first loading state and then changes from the first loading state to the second loading state.

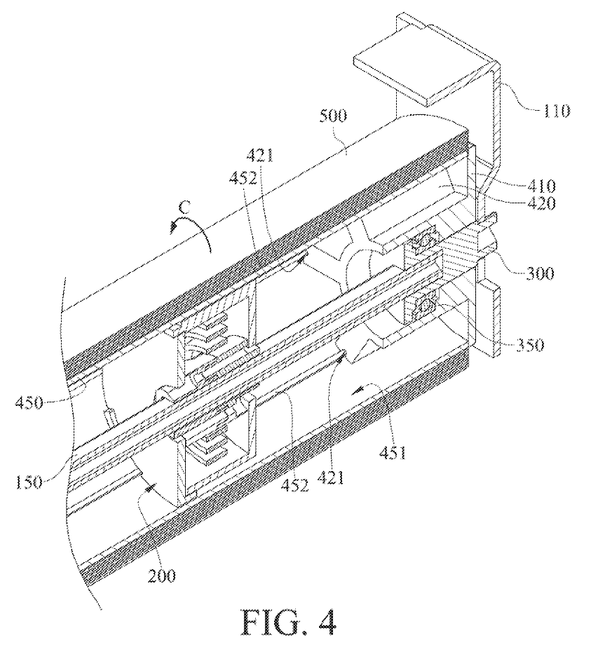

Please refer to FIGS. 2-4. FIG. 4 is a perspective cross-sectional view of the rolling structure 10 taken along line 4-4 in FIG. 1.

The two fasteners 300 are fixed to the two fixing plates 110, respectively. Two opposite ends of the fixed rod 150 are fixed to the two fasteners 300, respectively. The two supporting cover plates 400 are rotatably disposed on the two fasteners 300 via the two bearings 350, respectively. The two supporting cover plates 400 each include a cover body 410 and an assembling body 420. The assembling body 420 protrudes from the cover body 410 axially and is in, for example, an impeller shape.

The roller 450 is sleeved on the outer barrels 220 of the holding devices 200. In detail, the roller 450 has, for example, an axial through hole 451. The holding devices 200 are located in the axial through hole 451. The fixed rod 150 is disposed through the axial through hole 451, and is disposed through the cover bodies 410 and the assembling bodies 420 of the two supporting cover plates 400. The two cover bodies 410 of the two supporting cover plates 400 are respectively disposed on two opposite ends of the roller 450, and cover the axial through hole 451. Also, the roller 450 is located between the two fixing plates 110.

As shown in FIGS. 3 and 4, the assembling body 420 has a plurality of first engagement structures 421. The roller 450 has a plurality of second engagement structures 452. The first engagement structures 421 are arranged along a circumferential direction C of the roller 450. The second engagement structures 452 are arranged along the circumferential direction C. The first engagement structures 421 and the second engagement structures 452 are recesses and protrusions matching each other and are engaged with each other. For example, the first engagement structures 421 are engagement recesses, and the second engagement structures 452 are engagement protrusions.

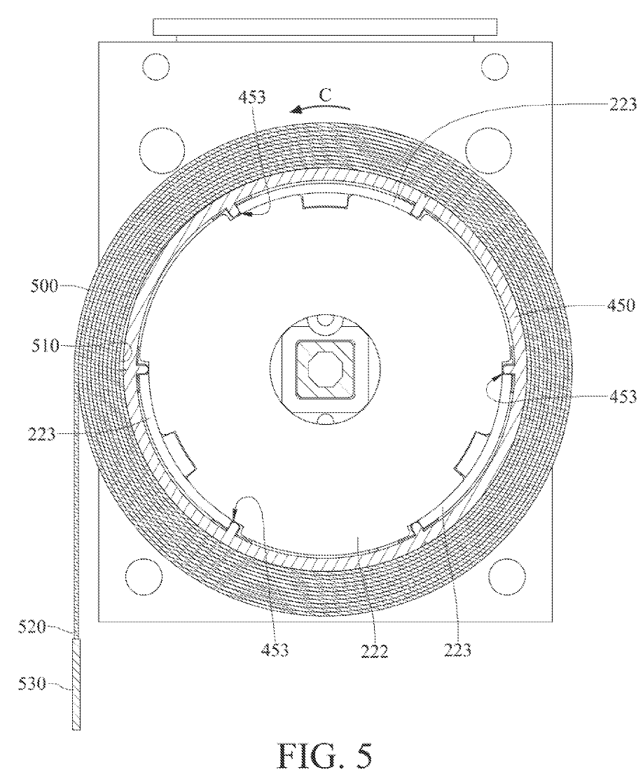

Please refer to FIGS. 3 and 5. FIG. 5 is a cross-sectional view of the rolling structure 10 taken along line 5-5 in FIG. 1. The roller 450 further has a plurality of third engagement structures 453. The base 221 has a plurality of fourth engagement structures 223. The third engagement structures 453 are arranged along the circumferential direction C. The fourth engagement structures 223 are arranged along the circumferential direction C. The third engagement structures 453 and the fourth engagement structures 223 are recesses and protrusions matching each other and are engaged with each other. For example, the third engagement structures 453 are engagement recesses formed between adjacent second engagement structures 452, and the fourth engagement structures 223 are engagement protrusions.

As shown in FIG. 5, the rollable piece 500 is, for example, a curtain. Also, a side of the rollable piece 500 is fixed to the roller 450. That is, the side of the rollable piece 500 is fixed to the outer barrel 220 via the roller 450. For example, the rollable piece 500 has a fixed side 510 and a movable side 520 opposite to each other. The fixed side 510 is fixed to the roller 450. There may be a handheld plate 530 disposed on the movable side 520 of the rollable piece 500 to facilitate the operation of the rollable piece 500.

Note that this embodiment schematically shows two holding devices 200, but the disclosure is not limited thereto. In other embodiments, there may be one or there or more holding devices according to the size of the rollable piece.

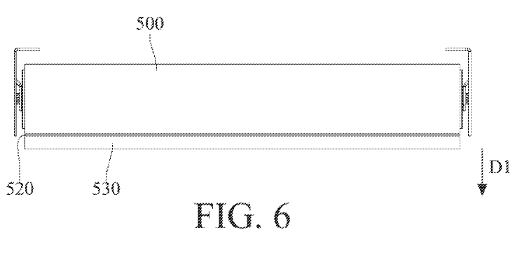

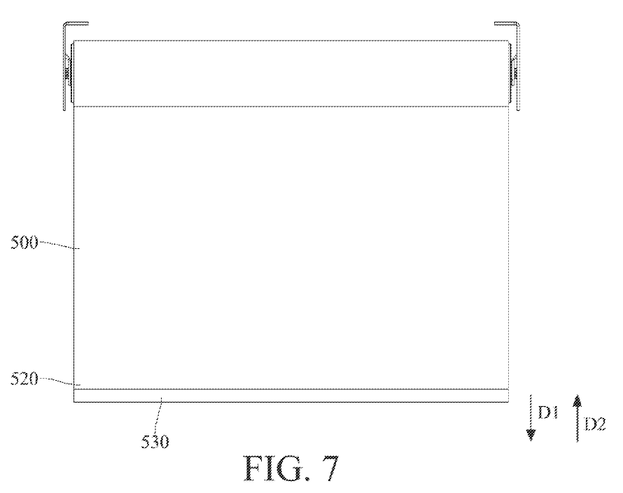

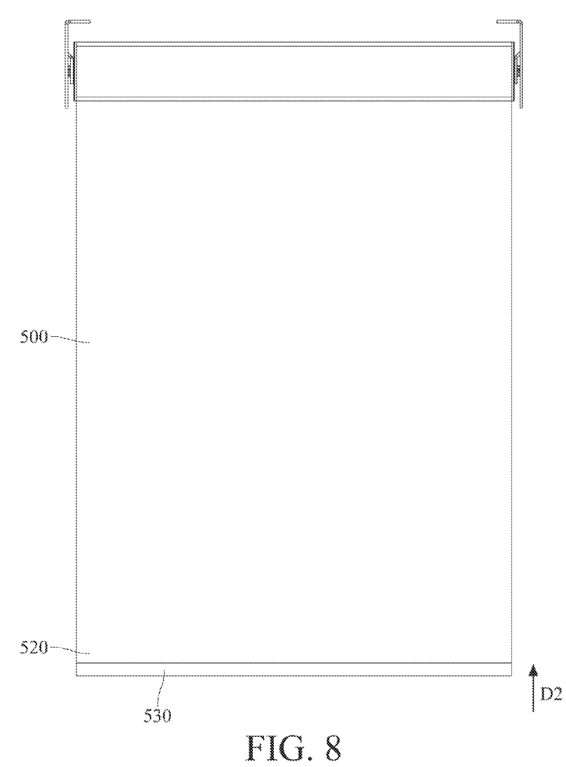

Please refer to FIGS. 2 and 6-8 . FIGS. 6-8 show the operation of the rolling structure 10 in FIG. 1. When the handheld plate 530 is held, the handheld plate 530 may be pulled along a lowering direction D1 or pushed along a raising direction D2 opposite to the lowering direction D1, and the handheld plate 530 is allowed to be held in any suitable height with the help of the elastic plate 230. In detail, as shown in FIGS. 2 and 6, when the rollable piece 500 is entirely wound on the roller 450, the elastic plate 230 is in the first loading state. As shown in FIGS. 2 and 7, when the rollable piece 500 is partially wound on the roller 450, the elastic plate 230 is still in the first loading state. As shown in FIGS. 2 and 8, when the rollable piece 500 is entirely unwound from the roller 450, the elastic plate 230 is still in the first loading state. That is, regardless of the degree by which the rollable piece 500 is unwound (i.e., regardless of the height of the movable side 520), the elastic plate 230 is in the first loading state to provide a nearly constant elastic force. In this way, a user is allowed to manipulate the handheld plate 530 by similar labor during both of the unwinding process of the rollable piece 500 performed by pulling the handheld plate 530 along the lowering direction D1 and the winding process of the rollable piece 500 performed by pushing the handheld plate 530 along the raising direction D2. Thus, the user experience is enhanced and the elastic plate 230 is allowed to held the movable side 520 in any height when the handheld plate 530 is released.

Furthermore, with the help of the bearings 350, the two supporting cover plates 400 are allowed to be rotated smoothly relative to the fasteners 300, thereby facilitating the operation of the rollable piece 500 (i.e., saving the labor for manipulating the rollable piece 500).

According to the rolling structure disclosed by above embodiments, the outer barrel and the inner barrel are coaxial, and two opposite ends of the elastic plate wound into loops are fixed to the outer barrel and the inner barrel, respectively. Thus, the elastic force generated by the elastic plate holds the rollable piece in the desired height after the rollable piece is released. In this way, the rollable piece is facilitated to be lowered/raised while allowing the rolling structure to meet the safety standard.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A rolling structure, configured to be fixed to a supporting surface and comprising:
a fixing bracket, configured to be fixed to the supporting surface;
a fixed rod, fixed to the fixing bracket;
at least one holding device, comprising an inner barrel, an outer barrel and an elastic plate, wherein the inner barrel is sleeved on and fixed to the fixed rod, the outer barrel is rotatably sleeved on the inner barrel, the outer barrel and the inner barrel are coaxial, the elastic plate is wound into loops, and two opposite ends of the elastic plate are fixed to the outer barrel and the inner barrel, respectively; and
a rollable piece, wherein a side of the rollable piece is fixed to the outer barrel.

2. The rolling structure according to claim 1, wherein the elastic plate comprises a first loading state and a second loading state, an elastic force generated by the elastic plate in the first loading state is greater than an elastic force generated by the elastic plate in the second loading state, when the elastic plate that is totally wound is unwound, the elastic plate changes from the second loading state to the first loading state and then changes from the first loading state to the second loading state, when the rollable piece is totally wound on the outer barrel, the elastic plate is in the first loading state, when the rollable piece is totally unwound from the outer barrel, the elastic plate is in the first loading state.

3. The rolling structure according to claim 1, wherein the fixing bracket comprises two fixing plates, and two opposite ends of the fixed rod are fixed to the two fixing plates, respectively.

4. The rolling structure according to claim 3, further comprising a roller, wherein the roller is sleeved on the outer barrel, the side of the rollable piece is fixed to the roller, and the roller is located between the two fixing plates.

5. The rolling structure according to claim 4, further comprising two supporting cover plates, wherein the roller has an axial through hole, the at least one holding device is located in the axial through hole, the fixed rod is disposed through the axial through hole and the two supporting cover plates, the two supporting cover plates are respectively disposed on two opposite ends of the roller and cover the axial through hole, and the two supporting cover plates are rotatably disposed on the two fixing plates, respectively.

6. The rolling structure according to claim 5, further comprising two fasteners and two bearings, wherein the two fasteners are fixed to the two fixing brackets, respectively, two opposite ends of the fixed rod are fixed to the two fasteners, respectively, and the two supporting cover plates are rotatably disposed on the two fasteners via the two bearings, respectively.

7. The rolling structure according to claim 5, wherein the two supporting cover plates each comprise a cover body and an assembling body, the assembling body protrudes from the cover body axially, the assembling body has a plurality of first engagement structures, the roller has a plurality of second engagement structures, the plurality of first engagement structures are arranged along a circumferential direction of the roller, the plurality of second engagement structures are arranged along the circumferential direction, the plurality of first engagement structures and the plurality of second engagement structures are recessed and protrusions matching each other and are engaged with each other.

8. The rolling structure according to claim 7, wherein the outer barrel comprises a base and a side cover, the elastic plate is located in the base, and the side cover is disposed on a side of the base and covers the elastic plate.

9. The rolling structure according to claim 8, wherein the roller further has a plurality of third engagement structures, the base has a plurality of fourth engagement structures, the plurality of third engagement structures are arranged along the circumferential direction, the plurality of fourth engagement structures are arranged along the circumferential direction, and the plurality of third engagement structures and the plurality of fourth engagement structures are recesses and protrusions matching each other and are engaged with each other.

10. The rolling structure according to claim 1, wherein the at least one holding device comprises a plurality of holding devices spaced apart from each other axially.
